(19) United States
(12) Patent Application Publication
(10) Pub. No.: US 2008/0223820 A1
(43) Pub. Date: Sep. 18, 2008

(54) METHOD FOR FORMING MINIATURE WIRES

(75) Inventors: Yung-Hsiang WU, Fengyuan City (TW); Je-Ping HU, Hsinchu (TW); Ming-Huan YANG, Shenkang Hsiang (TW); Chun-Jung CHEN, Yuanchang Hsiang (TW); Chien-Hung LIU, Banciao City (TW)

Correspondence Address: Muncy, Geissler, Olds & Lowe, PLLC, P.O. BOX 1364, FAIRFAX, VA, 22038-1364, US

(73) Assignee: INDUSTRIAL TECHNOLOGY RESEARCH INSTITUTE, Hsinchu (TW)

(21) Appl. No.: 12/034,509

(22) Filed: Feb. 20, 2008

Related U.S. Application Data
(63) Continuation-in-part of application No. 10/833,209, filed on Apr. 26, 2004, now abandoned.

(51) Int. Cl. H01B 13/00

(52) U.S. Cl. 216/13

(57) ABSTRACT

A method for forming miniature wires by printing or dispensing a solution on a substrate, the solution comprising a solute being capable of being etched and forming an inner and outer region on the substrate, each region having a thickness. After an etching process is applied on the substrate, the region inner region is removed so the outer region remains as desired wires. A line width of thus formed wires is narrowed to reach micron-scale wires.

### CROSS-REFERENCE TO RELATED APPLICATION

This application is a continuation in part of U.S. application Ser. No. 10/833,209, filed Apr. 26, 2004, entitled “Method for forming wires of sub-micron order scale”.

### BACKGROUND OF THE INVENTION

1. Field of the Invention

The present invention pertains to a method for forming miniature wires in micron scale, sub micron scale or nano scale, and more particularly to a method in which the width of created wires can be further narrowed by etching based on a “coffee ring” effect.

2. Description of Related Art

Most electronic components are fabricated through semiconductor manufacturing processes in which photolithography is adopted for transferring circuit patterns from a photo-mask to a target such as a substrate. However, the application of such a high-cost photolithography process has some limitations that are difficult to overcome. Therefore, many techniques intended to replace the photolithography process have been developed in recent years. A direct writing process is applied to create circuit patterns or components by printing an appropriate substance on substrates from a nozzle.

The advantages of the direct printing process include the following points.

1. High cost of manufacture associated with using the photo-mask is reduced and the process is suitable to fabricate a small number of high-price products.

2. An effective use rate of consumptive raw materials is increased from 5% when using a conventional spin coating process to 95% with the direct printing process.

3. The direct printing process is suitable for different types of target substrates, the target substrate may even have a curved surface or flexible, or both.

Even though the direct printing process has the foregoing advantages, some problems still need to be overcome, especially controlling width of the printed wires. Currently, a minimum drop size of an ejected substance is 20 pL. (pico-liters). The width of wire created by printing is approximate 30 μm (micro-meters). Such a technique level is only suitable to create circuits on printed circuit boards (PCB).

With reference to FIG. 7, however, using the direct printing process to fabricate driving circuits of thin film transistors (TFT) has yet to be achieved with existing technology. For circuits that require a 3 μm wire width, the drop size should be in a range of femto-liter (wherein 1 fL 10⁻¹ L). To obtain the nano-scale drop size, the opening diameter of the nozzle should be minimized accordingly. However, to develop a novel nozzle with such small nozzle diameter would create difficulties of high manufacturing cost, low yield, or shortening the use life of the nozzle etc.

Many companies and institutions have invested many resources to develop new techniques concerning the direct printing. For example, Xenniz and Carclo developed a technique that is able to print conductive wires of 50 μm on a plastic or paper substance through the usage of piezoelectricity-based printing means. In the year 2000, R. H. Friend et al. published a printing technique that constructs “all polymer” transistors, however the 5 μm wires in the gate channel region are still implemented by the conventional photolithography process. Moreover, Tanja et al. of Princeton University also proposed a new technique in “Applied Physic Letters” using convective flow splitting phenomenon of non-volatilizable solution forming initial wires of 500 μm by dispensing the solution onto the substrate. After the solvent has evaporated, the initial wires of 500 μm are shrink to 100 μm wires. They further claim that a technique for printing the solution to form initial wires of 80 μm would produce wires of to 10 μm in width (see Tanja Cuk, “Using convective flow splitting for the directing printing of copper lines” Appl. Phys. Vol 77, No. 13, P2063).

With reference to FIG. 8A, copper solution (700) is printed on a substrate (70) to form a wire of 80 μm. Through a drying process, copper solute (72) contained in the solution (700) remains on the substrate (70) as shown in FIG. 8B. During the drying process, a coffee ring effect would occur thus forming central (72A) and edge regions (72B) each having a thickness. The thickness of the central region (72B) of the copper solute (72) is thinner than edge regions (72A) of the copper solute (72). The width of the wire at each edge formed by copper solute (72) is approximately 10 μm.

Even though the foregoing printing process is capable of creating narrow wires at opposite edges, the middle region (72B) still remains on the substrate (70) and is connected to both edges (72A). Therefore, the entire remaining copper solute (72A)(72B) is deemed as one independent wire and unsuitable for practical application.

Another wire forming method is disclosed in the U.S. Patent application, publication number 2003/0151650. As shown in FIGS. 1A to 1F of the publication application, a dispersion formed by dispersing a dispersoid in a dispersion medium is ejected onto a substrate.

After the dispersion is spread over the substrate to form a desired pattern, the substrate on which the dispersion has landed is heated to vaporize the dispersion medium and only the dispersoid is left on the substrate, again displaying the coffee cup effect, with thin central and thick edge regions.

Then, a dispersion medium is ejected onto the dispersoid remaining on the substrate. As a result, a part of the dispersoid is taken up into the dispersion medium. When the substrate upon which the dispersion medium has landed on the dispersoid is heated again, the dispersoid within the dispersion medium again convects, and the dispersoid that remained near the center is driven to both sides.

The dispersoid then can eventually be completely separated by multiple alternate additional injections and heat drying of the dispersion medium, creating multiple coffee ring effects to build up two independent lines and a central void.

As disclosed by the U.S. 2003/0151650, the dispersion medium is required to be precisely ejected onto the dispersoid remaining on the substrate. Therefore, the dispersion medium must be aimed at the dispersoid. Such high precision ejecting process is very inefficient and unsuitable for mass production of lines.

The wire forming process as proposed in the foregoing publications are quite complex and inefficient. Therefore, such wire-forming methods are not suitable for mass production of micron-scale wires.

### SUMMARY OF THE INVENTION

An objective of the present invention is to provide a method for forming miniature wires, wherein the line-width of the created independent wire is effectively narrowed.

To accomplish the objective, a method comprising acts of: applying a solution on a substrate, evaporating a solvent and etching the substrate.

Applying the solution on the substrate comprises the solution having a solvent and a solute dissolved therein, the solute being capable of being etched.

Evaporating the solvent of the solution comprises the solute remaining on the substrate and forming an outer region and an inner region, each region having a thickness.

Etching the solute remaining on the substrate comprising adding an etchant to remove the inner region and leave the outer region on the substrate as desired wires.

Other objects, advantages and novel features of the invention will become more apparent from the following detailed description when taken in conjunction with the accompanying drawings.

### BRIEF DESCRIPTION OF THE DRAWINGS

FIGS. 1A to 1D show processes of forming wires in accordance with the present invention;

FIGS. 2A and 2B are computer generated graphs of a created ‘coffee ring’ according to a first experiment in accordance with the present invention, before the coffee ring is etched;

FIGS. 3A and 3B are computer generated graphs of the coffee ring of FIG. 2A having been etched;

FIGS. 4A and 4B are computer generated graphs of a created ‘coffee ring’ according to a second experiment in accordance with the present invention, before the coffee ring is etched;

FIGS. 5A and 5B are computer generated graphs of the coffee ring of FIG. 4A having been etched;

FIGS. 6A and 6B are computer generated graphs of a coffee ring according to a third experiment in accordance with the present invention, wherein the coffee ring has been etched;

FIG. 7 shows a table in which the relationship among drop size, drop diameter and width of created wires are listed in accordance with the prior art; and

FIGS. 8A to 8B show a conventional printing process for forming wires in accordance with the prior art.

### DETAILED DESCRIPTION OF THE PREFERRED EMBODIMENT

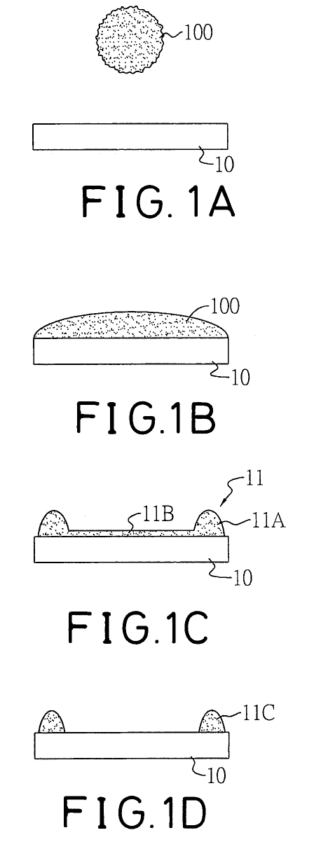

With reference to FIG. 1A, a solution (100) is directly dispensed on a substrate (10). The substrate (10) may be glass or plastic. The solution (100) comprises a solvent and an electrically conductive solute capable of being etched. The electrically conductive solute in the solution (100) can be etched and may be a metallic substance (such as copper), an organic substance (such as epoxy and polymethyl methacrylate (PMMA)), nano-conductors, semiconductors etc.

With reference to FIGS. 1B to 1C, after the solvent of the solution (100) has evaporated, the solute remaining on the substrate (10) forms a coffee ring configuration (11) due to the coffee ring effect. The coffee ring configuration (11) comprises an outer region (11A) and an inner region (11B) each having a thickness. The thickness of the outer region (11A) is thicker than the inner region (11B).

With reference to FIG. 1D, an etching process is applied on the substrate (10) to simultaneously etch the inner and outer regions (11A, 11B). Because an efficacy of the etching process is related by surface area, and the inner and outer regions (11A, 11B) are of different thickness, the inner region (11B) can be removed from the substrate (10) whilst the outer region (11A) is only slightly reduced and remains to form a wire. A wire width of the outer region (11A) is further reduced because of the etching process. When the entire coffee ring configuration (11) is exposed to the etchant, the thinner inner region (11B) is effectively removed selectively. Therefore, a photomask as used in conventional photolithography for defining which regions require etching and protection is not necessary in the etching process in accordance with the present invention. The advantage of the etching process is that the etchant is applied over the entire the substrate regardless of the position of the solute. The etchant does not need to be precisely applied on the substrate (10).

The foregoing processes create a ring shaped wire by dispensing solution drops. However, other desired patterns such as straight or curved lines are able to be created according to the foregoing processes by directly printing solution on the substrate in required patterns.

In order to prove that the width of the created wire is effectively narrowed in accordance with the present invention, several experiments are proposed hereinafter.

Experiment 1: The solute is PMMA and the solvent is anisole, wherein the concentration of the solution is 5%. The solution is printed on a glass substrate through a nozzle. After the anisole solvent has evaporated, a coffee ring configuration is formed on the glass substrate.

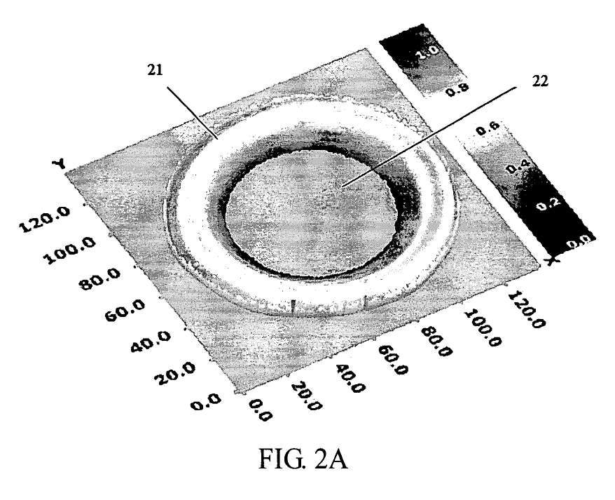

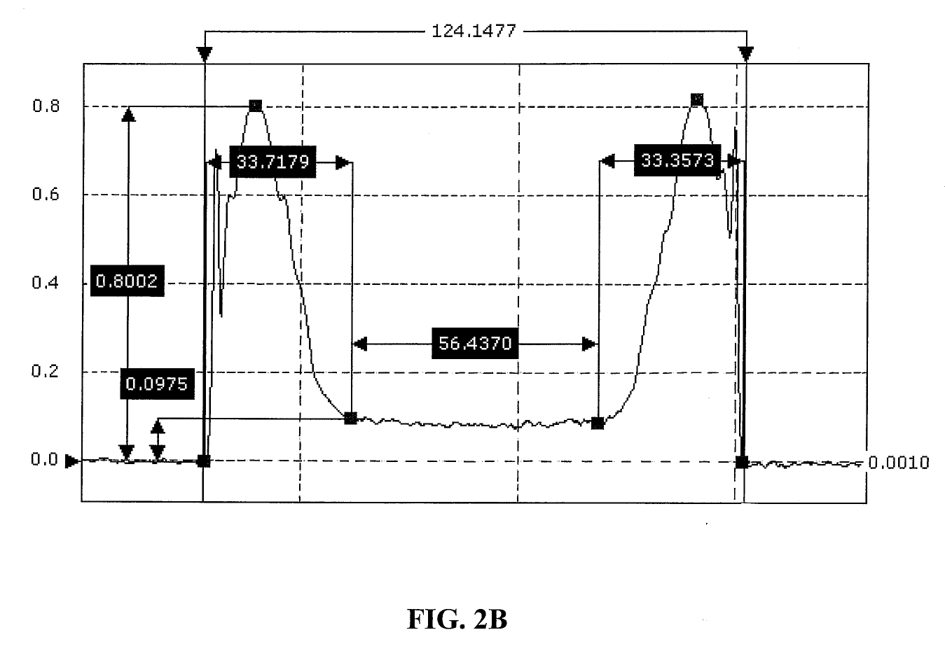

With reference to FIG. 2A, the outer region (21) is thicker than the inner region (22). A thickness distribution of a cross-section of the coffee ring is illustrated in FIG. 2B. A thickness of the outer region (21) is approximately 0.8 μm and the width is approximate 33 μm. The thickness of the inner region (22) is approximately 0.1 μm and its width is approximately 56 cm.

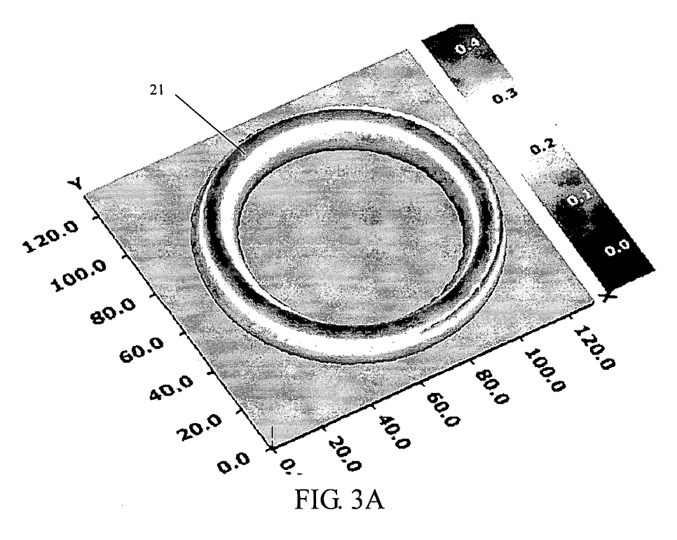

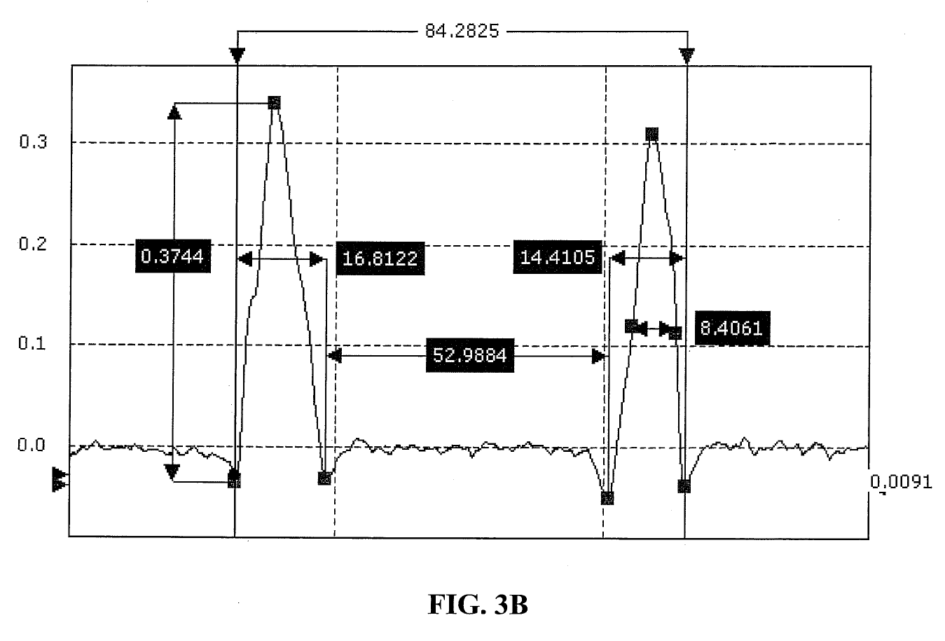

With reference to FIGS. 3A and 3B, after the etching process has been applied, the inner region (22) is removed and only a ring shaped outer region (21) remains on the glass substrate. The thickness of the outer region (21) is approximately 0.37 μm and the width is approximately 16.8 μm. The width measured at the half height of the remaining outer region (21), is only approximately 8 μm.

Experiment 2: The solute is PMMA and the solvent is anisole, wherein the concentration of the solution is 7%. The solution is also printed on a glass substrate to form a coffee ring configuration with two regions (31)(32) integrally formed together.

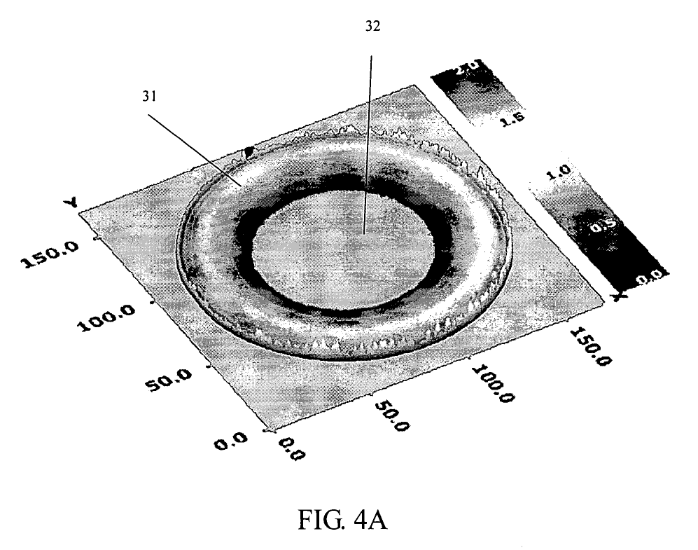

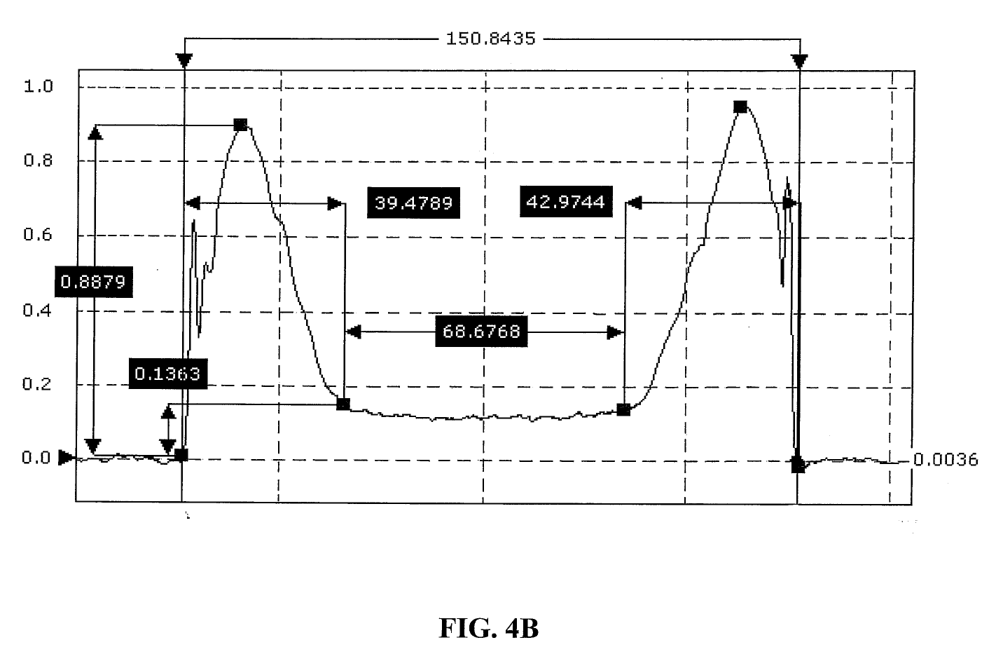

With reference to FIGS. 4A and 4B, the thickness of the outer region (31) is approximately 0.89 μm and the width is approximate 39 μm before the etching process. The thickness of the inner region (32) is approximately 0.14 μm and the width is approximately 64 μm.

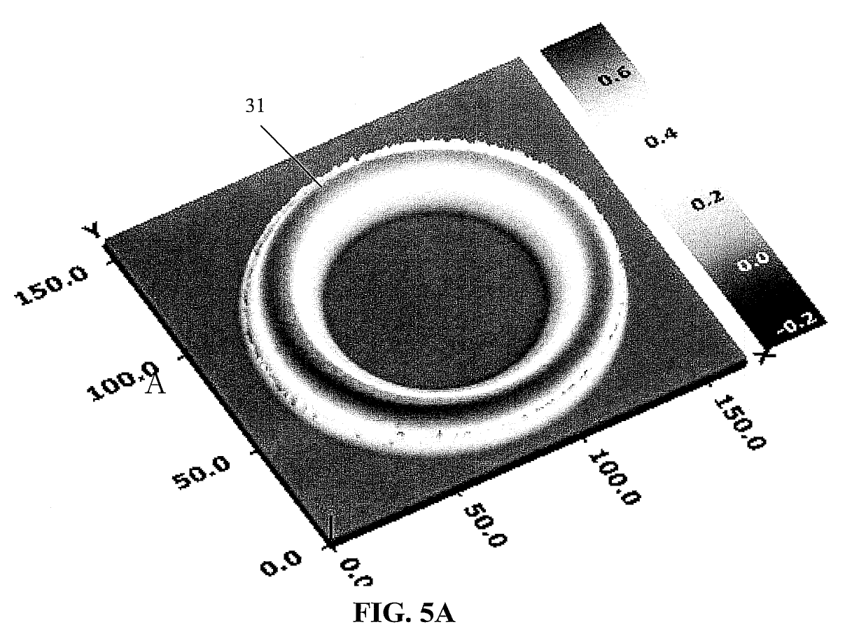

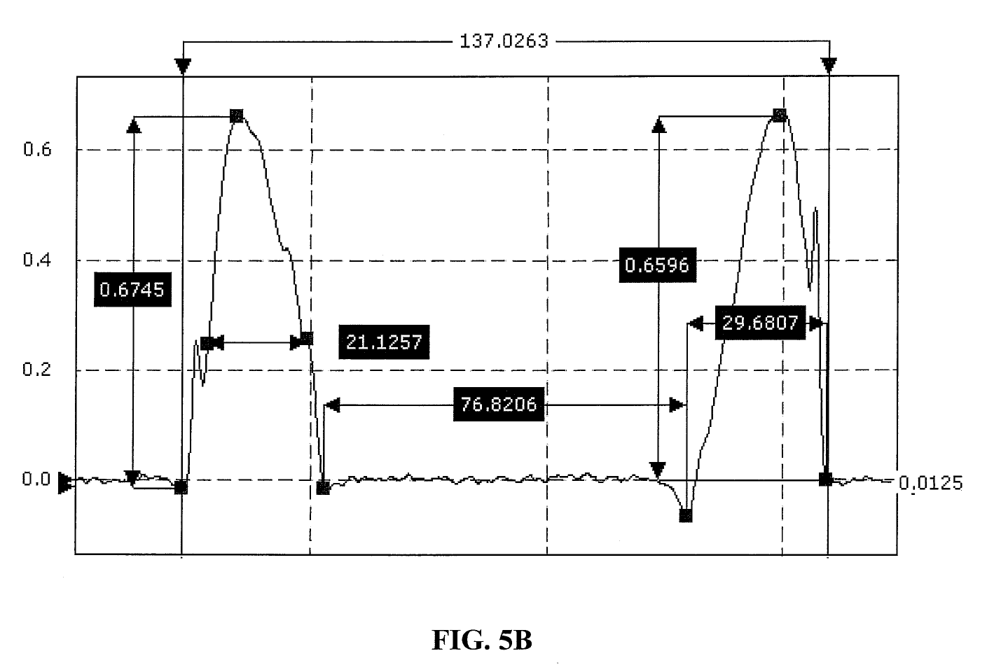

With reference to FIGS. 5A and 5B, after the etching process, the inner region (32) is removed and only a ring shaped outer region (31) remains on the glass substrate. The thickness of the outer region (31) is approximately 0.67 μm and the width is approximately 29.68 μm, wherein the width measured at the half height of the remaining outer region (31) is only approximately 21.1 μm.

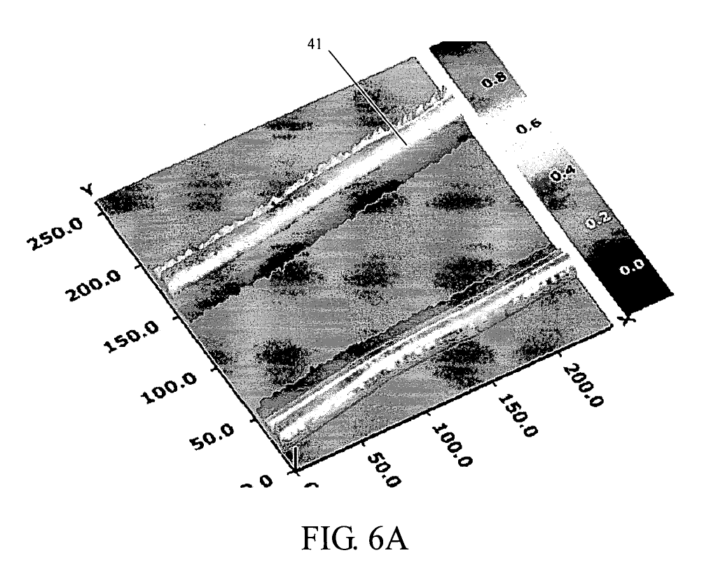

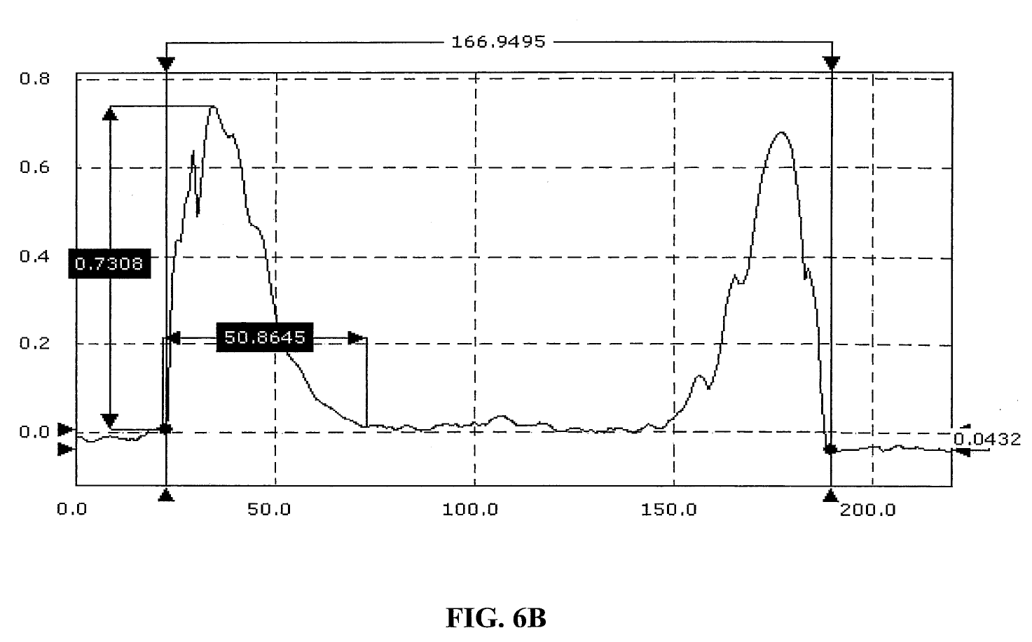

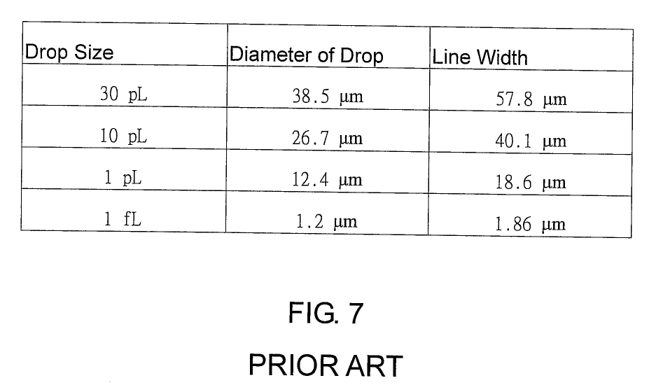

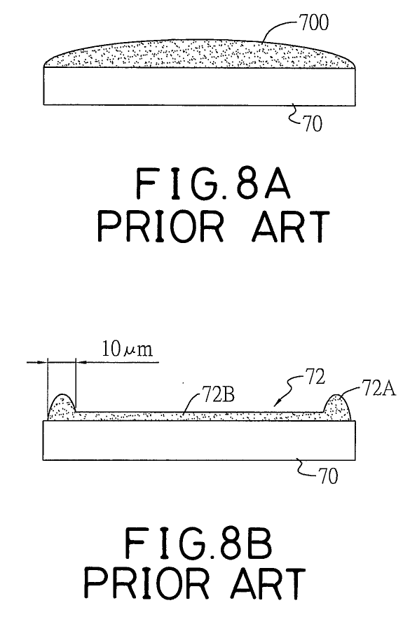

Experiment 3: The solute is PMMA and the solvent is anisole, wherein the concentration of the solution is 5%. The solution is printed on a glass substrate to form the straight wire with two regions integrally formed together. The outer region having the greater thickness includes the opposite edges of the straight wire, and the inner region is the center portion of the wire. With reference to FIGS. 6A and 6B, after the etching process, the inner region is removed and only a pair of straight lines (41) remains on the glass substrate. The thickness of the outer region (41) is approximately 0.73 μm and the width is approximately 50 μm.

In FIG. 6A, the two straight lines (41) are independent and parallel to each other. Such a pattern is very suitable for an application in which multiple circuit wires are designed to be parallel to each other. In a condition that only one straight line is necessary, the other one is accordingly ignored.

Based on the foregoing description, by providing the solution containing the solute capable of being etched on the substrate, the solute remaining on the substrate after the solvent is evaporated forms two regions with different thicknesses. Once an etching process is applied on the substrate, the region formed by the thinner solute is completely removed and the other, thicker region, is retained as the desired independent wire.

Moreover, another purpose of the present invention is to form the wire patterns of a photo-mask adopted in general semiconductor processes. The substrate (10) can be a mask target, whereby a photo-mask with miniature wires pattern can be achieved.

It is to be understood, however, that even though numerous characteristics and advantages of the present invention have been set forth in the foregoing description, the disclosure is illustrative only and changes may be made in detail, within the principles of the invention, to the full extent indicated by the broad general meaning of the terms in which the appended claims are expressed.

What is claimed is:

1. A method for forming wires or patterns, the method comprising acts of:
applying a solution on a substrate, the solution comprising a solvent and an electrically conductive solute capable of being etched;
evaporating the solvent of the solution applied on the substrate to leave the electrically conductive solute of the solution on the substrate, the electrically conductive solute remaining on the substrate forming an outer region and an inner region each having a thickness, the thickness of the outer region being thicker than the inner region; and
simultaneously etching both the outer region and the inner region of the electrically conductive solute remaining on the substrate to remove the inner region and reduce the outer region, the outer region thereby forming wires on the substrate as desired.

2. The method as claimed in claim 1, wherein a width of the outer region is smaller than a half width of the solution applied on the substrate.

3. The method as claimed in claim 1, wherein the solution is applied on the substrate by printing.

4. The method as claimed in claim 1, wherein the solution is applied on the substrate by dispensing.

5. The method as claimed in claim 1, wherein the desired wires formed by the outer region are ring shaped, linearly shaped or curved line shaped.

6. The method as claimed in claim 2, wherein the desired wires formed by the outer region are ring shaped, linearly shaped or curved line shaped.

7. The method as claimed in claim 3, wherein the desired wires formed by the outer region are ring shaped, linearly shaped or curved line shaped.

8. The method as claimed in claim 4, wherein the desired wires formed by the outer region are ring shaped, linearly shaped or curved line shaped.

9. The method as claimed in claim 1, wherein the electrically conductive solute is metallic, organic or a semiconductor.

10. The method as claimed in claim 2, wherein the electrically conductive solute is metallic, organic or a semiconductor.

11. The method as claimed in claim 3, wherein the electrically conductive solute is a metallic substance, an organic substance or a semiconductor substance.

12. The method as claimed in claim 4, wherein the electrically conductive solute is metallic, organic or a semiconductor.

13. The method as claimed in claim 1, wherein the substrate is a plastic substrate or a glass substrate.

14. The method as claimed in claim 2, wherein the substrate is a plastic substrate or a glass substrate.

15. The method as claimed in claim 3, wherein the substrate is a plastic substrate or a glass substrate.

16. The method as claimed in claim 4, wherein the substrate is a plastic substrate or a glass substrate.

17. The method as claimed in claim 1, wherein the substrate is a photo-mask substrate for forming a photo-mask.
